(19) United States
(12) Patent Application Publication
(10) Pub. No.: US 2020/0334702 A1
(43) Pub. Date: Oct. 22, 2020

(54) MIDDLE OUT LOYALTY

(71) Applicant: Comenity LLC, Columbus, OH (US)

(72) Inventors: Joseph BUTVIN, Columbus, OH (US); Michael HANCOCK, Columbus, OH (US); Elizabeth PAPAS, Columbus, OH (US)

(73) Assignee: Comenity LLC, Columbus, OH (US)

(21) Appl. No.: 16/838,925

(22) Filed: Apr. 2, 2020

Related U.S. Application Data
(60) Provisional application No. 62/835,951, filed on Apr. 18, 2019.

(51) Int. Cl. G06Q 30/02

(52) U.S. Cl. CPC G06Q 30/0226

(57) ABSTRACT

A system and method for dynamically assigning a middle out loyalty is disclosed. The method and system obtains a number of customer specific characteristics for a co-brand account holder. In addition, one or more brand partners for a brand providing a co-brand account of the co-brand account holder is also obtained. The customer specific characteristics of the co-brand account holder are used in conjunction with the brand requirements to generate a dynamic middle out loyalty offer customized for the co-brand account holder. Automatically, and after a time period expires, using the customer specific characteristics of the co-brand account holder in conjunction with the brand requirements to dynamically generate a new middle out loyalty offer customized for the co-brand account holder.

### CROSS-REFERENCE TO RELATED APPLICATIONS (PROVISIONAL)

This application claims priority to and benefit of co-pending U.S. Provisional Patent Application No. 62/835,951 filed on Apr. 18, 2019, entitled “MIDDLE OUT LOYALTY” by Butvin et al., and assigned to the assignee of the present application, the disclosure of which is hereby incorporated by reference in its entirety.

### BACKGROUND

Middle Out Loyalty (MOL) is a concept where a dynamic value proposition is applied to the “middle” of the value prop, to change how rewards are earned. Today, many lose tender share on cobrand programs when new cards are introduced with a better value prop (i.e. card A offers 2% back on gas, then card B offers 4% back on gas). MOL will allow that middle category to change on a daily/weekly/monthly basis, providing the cardmember with a gamification approach to earning rewards with their card.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description should not be understood as being drawn to scale unless specifically noted.

FIG. 1 is a block diagram of a mobile device, in accordance with an embodiment.

FIG. 2 is a block diagram of a middle out loyalty system, in accordance with an embodiment.

FIG. 3 is a mock-up diagram of different middle out loyalty presentations on a display screen of a mobile device, in accordance with an embodiment.

FIG. 4 is a flowchart of a method for providing dynamic middle out loyalty, in accordance with an embodiment.

FIG. 5 is a block diagram of an example computer system with which or upon which various embodiments of the present invention may be implemented.

### DESCRIPTION OF EMBODIMENTS

Reference will now be made in detail to embodiments of the subject matter, examples of which are illustrated in the accompanying drawings. While the subject matter discussed herein will be described in conjunction with various embodiments, it will be understood that they are not intended to limit the subject matter to these embodiments. On the contrary, the presented embodiments are intended to cover alternatives, modifications and equivalents, which may be included within the spirit and scope of the various embodiments as defined by the appended claims. Furthermore, in the Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

### Notation and Nomenclature

Unless specifically stated otherwise as apparent from the following discussions, it is appreciated that throughout the present Description of Embodiments, discussions utilizing terms such as “selecting”, “outputting”, “inputting”, “providing”, “receiving”, “utilizing”, “obtaining”, “updating”, “accessing”, “changing”, “correlating”, “prescreening”, “developing”, “presenting” or the like, often refer to the actions and processes of an electronic computing device/system, such as a desktop computer, notebook computer, tablet, mobile phone, and electronic personal display, among others. The electronic computing device/system manipulates and transforms data represented as physical (electronic) quantities within the circuits, electronic registers, memories, logic, and/or components and the like of the electronic computing device/system into other data similarly represented as physical quantities within the electronic computing device/system or other electronic computing devices/systems.

The term “store” is used herein to describe a specific place where one or more products can be bought or sold. It can be a brick and mortar location such as “Stanley shoe store at 1 main street”, it can be a virtual location such as a website (www.stanley.shoe), or the like.

The term “retailer” is used herein to describe the specific store (e.g., the Stanley shoe store at 1 main street) or website that provides goods and/or services.

The term “brand” is used herein to describe a collection of retailer's stores (e.g., Stanley shoes).

The term “private label credit card” (PLCC) is used herein to describe a credit card that is intended for use at a specific brand of stores. The PLCC is a type of revolving credit plan managed by a bank or commercial finance company. The PLCC is often issued without an expiration date.

The term “co-branded card” is used herein to describe a general purpose open-end revolving line of credit which is established by a credit provider for an accountholder pursuant to the terms of a credit agreement and in accordance with card association rules and regulations, and marketed with retailer's mark and the trade names and/or logos of a card association.

The term “customer” and “account holder” are used herein to describe a person that has obtained at least one PLCC, or co-branded credit account. The credit account could include a physical card, a virtual card, a digital card, or a combination of different card formats.

It should be appreciated that the obtaining, accessing, or utilizing of information conforms to applicable privacy laws (e.g., federal privacy laws, state privacy laws, etc.).

### Overview

Many match industry standards with their value propositions, being some sort of 3-2-1 point structure that results in the customer earning gift cards that can be used at the brand. E.g., 3% back at brand, 2% at gas and groceries, 1% on everything else. Such a format tends to tie the middle category (e.g., the 2%) to a category based off results of the value proposition process, such as Gas and Groceries in this example. However, since the 3-2-1 structure remains static, as soon as a new card program is introduced with a more compelling value proposition the card provider will lose wallet share as the cardholder will choose to use the new card over the original card.

In one embodiment, as will be described herein, the dynamic middle out loyalty differs significantly from the conventional use case. In conventional approaches, credit account providers deploy a lengthy and costly process to arrive at ideal value propositions for brand partners. While this solution has been successful for some businesses, the end result often leaves programs in the middle-to-bottom of wallet space. For example, if the 2% back is gas, and the customer lives in a city or doesn't have a car, then there is less motivation for the customer to use the card since the customer will not be obtaining any 2% back on their spending. The customer would rather use a different card that provides a 2% back at a place they do make purchases, such as a bookstore or the like.

Importantly, the various embodiments of the present invention do not merely implement conventional middle out loyalty processes on a computer. Instead, the present embodiments, as will be described and explained below in detail, provide a novel approach for using middle out loyalty where dynamic rewards are applied to the “middle” of the value proposition. That is, middle out loyalty provides different embodiments that allow the middle out (e.g., the 2% cash back of the card) to have a flexible, dynamic, adjustable value proposition that provides incentive for a customer to use the cobrand card more often for both in-brand and out-of-brand purchases. E.g., provide incentive to have the customer use the co-brand card more often thereby moving the cobrand card toward a top-of-wallet location (e.g., the customer making the co-brand card their go to card).

Moreover, the embodiments do not recite a mathematical algorithm; nor do they recite a fundamental economic or longstanding commercial practice. Instead, they address a challenge to make a credit account the top of wallet card, in a “what have you done for me lately” environment that has been created and continues to rapidly evolve in the Internet-centric connected world.

Thus, the embodiments do not merely recite the performance of some business practice known from the pre-Internet world along with the requirement to perform it on a computing device. Instead, the embodiments illustrate a novel, clearly applied, specific solution to regain customer loyalty in the realm of real-time offers from different credit account providers that cardholders are continuously bombarded with in the growing digital environment that includes offers via email, via web-surfing, via pop-ups, and the like.

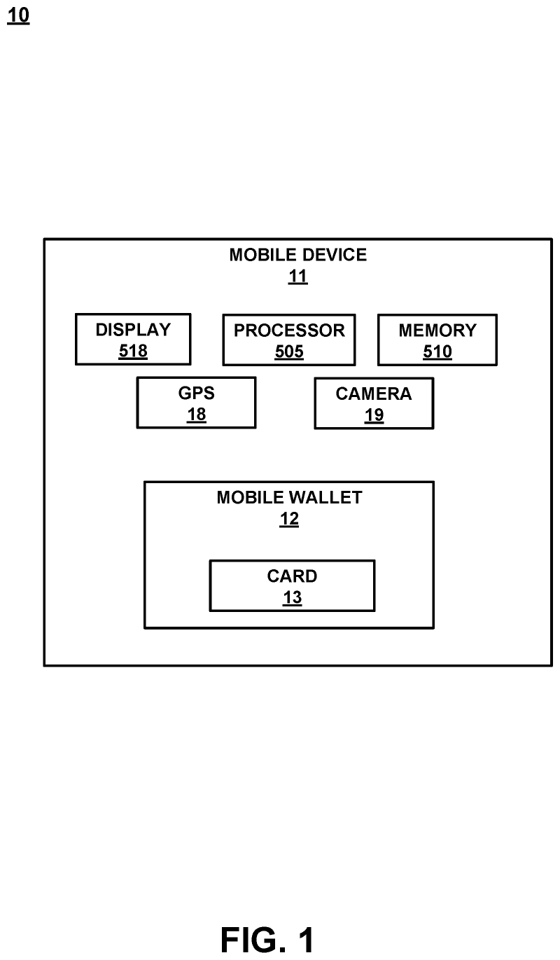

Referring now to FIG. 1, a block diagram 10 of a mobile device 11 is shown. Although a number of components are shown as part of mobile device 11, it should be appreciated that other, different, more, or fewer components may be found on mobile device 11.

In general, mobile device 11 is an example of a customer's mobile device, a store's mobile device, an associate's mobile device, or the like. Mobile device 11 could be a mobile phone, a smart phone, a tablet, a smart watch, a piece of smart jewelry, smart glasses, or other user portable devices having wireless connectivity. For example, mobile device 11 would be capable of broadcasting and receiving via at least one network, such as, but not limited to, WiFi, Cellular, Bluetooth, near field communication (NFC), and the like. In one embodiment, mobile device 11 includes a display 518, a processor 505, a memory 510, a GPS 18, a camera 19, and the like. In one embodiment, instead of providing GPS information, the location of mobile device 11 may be determined within a given radius, such as the broadcast range of an identified beacon, a WiFi hotspot, overlapped area covered by a plurality of mobile telephone signal providers, or the like.

Mobile device 11 also includes a digital or mobile wallet 12 (or the like) which is an electronic application that operates on mobile device 11. Mobile wallet 12 includes digital co-branded card 13. Although digital co-branded card 13 is shown as part of mobile wallet 12, it should be appreciated that digital co-branded card 13 could be located in a different application operating on mobile device 11, or stored elsewhere such as part of an email, text, or the like. In one embodiment, co-branded card 13 is a physical card. In one embodiment, the co-branded card could be provided to the customer in both a physical card and a virtual card.

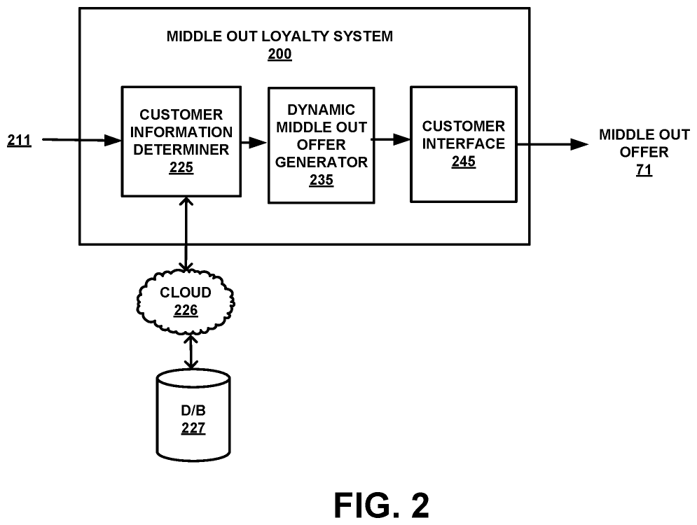

With reference now to FIG. 2, a block diagram of the middle out loyalty system 200 is shown in accordance with an embodiment. FIG. 2 includes mobile device 11, middle out loyalty system 200, cloud 226, database 227, and middle out offer 71.

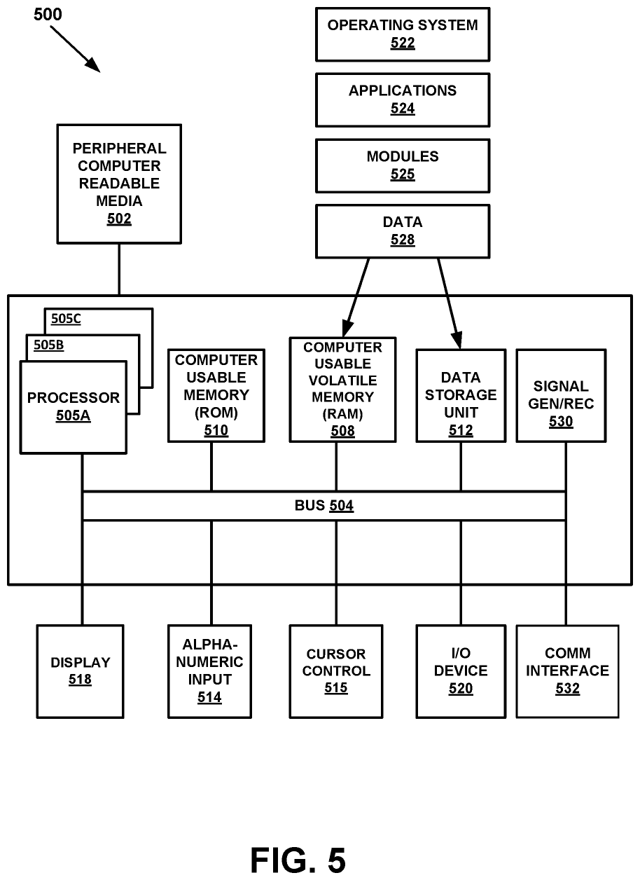

In one embodiment, middle out loyalty system 200 is a computing system such as computer system 500 described in detail in the FIG. 5 discussion herein. In one embodiment, middle out loyalty system 200 includes a customer information determiner 225, a dynamic middle out offer generator 235, and a customer interface 245.

In one embodiment, middle out loyalty system 200 receives a customer contact 211. In one embodiment, the customer contact 211 is used to obtain, review or request a middle out offer for the co-branded card. In one embodiment, the customer contact 211 is initiated by the customer's mobile device. In one embodiment, the customer contact 211 is initiated by the customer's work or home computer system. In one embodiment, the customer contact 211 is initiated by the brand's computing device. In one embodiment, the customer contact 211 is initiated by the credit account provider's computing device.

In one embodiment, the customer contact 211 is received by the middle out loyalty system 200 via the cloud, mobile network, WiFi, or the like. In another embodiment, middle out loyalty system 200 receives the customer contact 211 from a website that has been accessed by from a customer's computing device (e.g., via the cloud, WiFi, mobile network, or the like).

In one embodiment, customer information determiner 225 accesses database 227 via cloud 226 to obtain customer information.

An example of cloud 226 is a network such as the Internet, local area network (LAN), wide area network (WAN), or the like. Database 227 could be a local database, a virtual database, a cloud database, a plurality of databases, or a combination thereof. In one embodiment, database 227 includes customer information such as, but not limited to, shopping preferences, credit account(s), shopping history, and the like.

In one embodiment, the customer information is provided to the dynamic middle out offer generator 235 which uses the customer information and any credit account provider information and/or brand information to generate one or more customer specific (or brand specific, account provider specific, or a combination thereof) middle out offer 71.

The middle out offer 71 is then provided from the middle out loyalty system 200 to the customer via the customer interface 245. In one embodiment, the middle out offer 71 is sent to the customer's mobile device 11, wherein an access of the digital co-branded card 13 (or a brand's app, or website) causes the middle out offer 71 to be presented to the customer. In one embodiment, the middle out offer 71 is provided to the customer from middle out loyalty system 200 via a delivery method such as, but not limited to: a text, an email, a mobile push to a mobile wallet 12, via a network such as near field communication (NFC), Bluetooth, WiFi, or the like.

For example, the customer interface 245 will send a message to mobile device 11 which will include the middle out offer 71 information such that the opening of the text message will result in the presentation of the middle out offer 71. In a mobile push scenario, the customer interface 245 will push the middle out offer 71 to the customer's computing device.

In one embodiment, middle out offer 71 could be provided on a paper statement provided to the customer (e.g., a monthly statement or the like), sent in an email, regular mail, accessed from the customer via a website, app, or the like. The use of a customer's mobile device is one exemplary embodiment for providing the middle out offer 71 information to the customer.

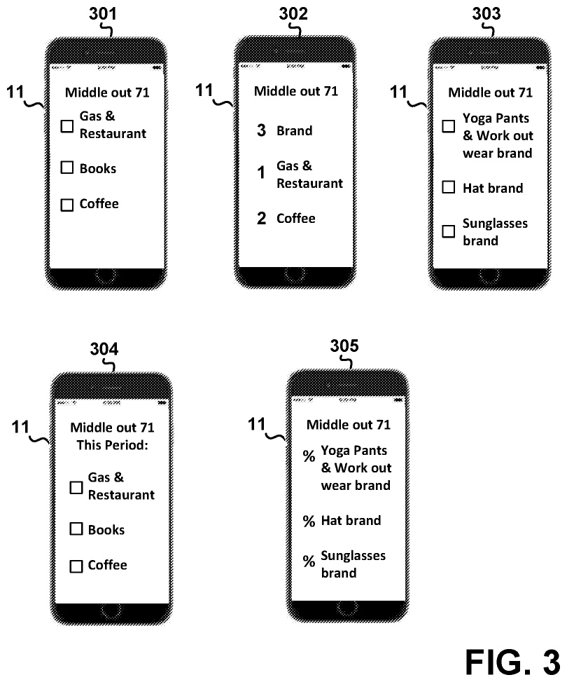

Referring now to FIG. 3, block diagrams of a plurality of middle out loyalty options presented on a display screen 518 of a mobile device 11 is shown in accordance with an embodiment.

Although a plurality of screenshots is shown, it should be appreciated that the screenshots are provided for purposes of example and clarity. In one embodiment, one or more of the screenshots may differ in information from what is actually shown based on personal preference, legislation, retail application preference and the like. Moreover, although middle out offer 71 screenshots are shown on a mobile device 11, in one embodiment, middle out offer 71 could be provided on a paper statement provided to the customer (e.g., a monthly statement or the like), sent in an email, regular mail, accessed from the customer via a website, app, or the like. The use of screenshots herein is merely one embodiment for providing the middle out offer 71 information to the customer.

Screenshot 301 shows an embodiment of a middle out offer 71 with a customer selectable choice of a category for the middle out loyalty in conjunction with one embodiment. In other words, the customer can choose the category for the middle out value (e.g., the 2% back) from a number of different categories. For example, the customer could choose the middle value to be tied to gas purchases, coffee purchases, restaurant purchases, book purchases, and the like.

Screenshot 302 shows an embodiment of a middle out offer 71 where the customer selectable choice of a category is for any one of the reward tiers, for a value other than the middle value, or the like. For example, the customer could adjust the category of any of the three different percentage values. In one embodiment, the customer has a selectable choice of category for a plurality of the value tiers. In one embodiment, the customer has a selectable choice of category for every reward tier except the top which is the brand reward tier. In one embodiment, the co-brand card will only have a single % back value and the customer can choose the type or category of the single % back value.

Screenshot 303 shows an embodiment of a middle out offer 71 uses a brand partner (or non-competitive brand) of the co-branded card. In one embodiment, the brand can let the customer choose (or the brand could specifically designate) another brand (non-competitive brand) for the middle value. For example, a shoe store cobrand card would have the middle out percentage be for purchases at a collaborative non-competitive brand such as, for example, a yoga pants/workout wear brand. Thus, the footwear brand would incentivize their customers to also shop at the collaborative yoga pants/workout gear. In one embodiment, the collaboration would be mutually coordinated between the brands. In one embodiment, the collaboration could be between more than two different brands, e.g., a footwear brand, yoga pants/workout wear brand, a hat brand, and a sunglasses brand. Although four brands are listed, it should be appreciated that there could be any number of brands working in collaboration.

Screenshot 304 shows an embodiment of a middle out offer 71 that changes (or is changeable) to different categories (or a different selection of a category) after a given time period, e.g., daily, weekly, monthly, or the like. For instance, using the category example 302 the customer has a cobrand footwear credit account and on Mondays and Thursdays, the middle out value is for purchases at the yoga pants/workout gear brand, on Tuesdays and Fridays the middle out value is for purchases at the hat brand, and on Wednesdays, the middle out value applies to purchases at the sunglasses brand.

In one embodiment, middle out offer 71 shown in screenshot 304 could us the brand example of 303 where the customer has a cobrand footwear credit account and on Mondays and Thursdays, the middle out value is for purchases at the yoga pants/workout gear brand, on Tuesdays and Fridays the middle out value is for purchases at the hat brand, and on Wednesdays, the middle out value applies to purchases at the sunglasses brand.

In one embodiment, middle out offer 71 shown in screenshot 304 could us a combination of brand and category.

Screenshot 305 shows an embodiment of a middle out offer 71 that has a changing value. For example, the customer has a cobrand footwear credit account and the middle out value is set for purchases at the yoga pants/workout gear brand. The first time the customer uses the middle out value at the yoga pants/workout gear brand the customer realizes a 2% cash back on purchases. However, for an amount of time after, the middle out value will increase for each follow on purchase made by the customer at the yoga pants/workout gear brand. For example, the second purchase within a given time frame (e.g., week, month, year, unlimited time), the customer will receive 3% cash back on purchases.

In one embodiment, the percentage back could continue to increase for each purchase made by the customer within the given time period, it could reach a certain max percentage back (e.g., 5% back) and then maintain the 5% back for the rest of the time period, it could return to the 2% back value after the second purchase, or some combination thereof.

In one embodiment, the middle out value could be for a changing category. For instance, the customer has a cobrand footwear credit account and each time period (e.g., day, week, month, year, etc.) the 2% back value could be applicable to a different, rotating, changing category. For example, the customer would receive an alert that the 2% back was for any food category purchases for the next week. In one embodiment, the alert could be an email, an alert from an app, information obtained from a website, or the like.

In one embodiment, the amount of times the customer uses the cobranded card would affect the value offered to the customer. For example, the customer receives the weekly alert and uses the cobrand card to purchase coffee, go to a restaurant, order food delivery, or the like. The next week, the new 2% category is gas, etc. In one embodiment, when the customer uses the cobrand card for the selected category, the customer could receive an additional reward, such as a coupon for a free coffee, an additional discount on a fuel purchase, or the like.

Thus, the customer would be receiving the 2% back when they used the card in the correct category and then would also obtain additional rewards based on the customer's actual purchase history. For example, if the customer made purchases in three different categories over three different time periods, the customer would receive an additional reward. In one embodiment, the customer could select the reward (e.g., a coupon, an extra % back on (all or select purchases) for a given time period, or the like. For example, the customer could receive an alert that they have made correlating purchases over the past 4 middle out changes and they are being rewarded with 5% cash back on every purchase made that day. In another example, the customer could be rewarded with a coupon for 15% off of a purchase. In one embodiment, the 15% off could be made for any of the collaborative brands, for a certain category, for any purchase, or the like.

In another example, the customer could receive an alert that they have made correlating purchases over the past 6 middle out changes and they are being rewarded with 7% cash back on the customer's selected category for the duration of the 7th middle out change.

In one embodiment, the middle out loyalty will also offer small repeatable tasks that will drive customer loyalty. For example, in one embodiment, there would be a repeatable timeframe having a task, wherein the value of the middle out loyalty can change, or other offers are obtained, when the customer performs one or more tasks for each repeatable timeframe. For example, the customer interface 245 could provide a task to a customer, where the task changes over a repeatable time period (e.g., hours, daily, weekly, monthly, or the like). When the customer performs the task for a given number of consecutive time periods (e.g., every week for a month), or for a given number of time periods over a larger time period (e.g., 20 daily tasks within a month), the customer obtains an increase or additional reward. In one embodiment, the task could be any type of task for the brand (or account provider) such as a social media post, an email to a friend, a review of a brand's product, a review of a customer-employee interaction, a survey, a joke, a story, or the like.

For example, by providing small repeatable tasks (that are somewhat easy to complete) that will provide an increase in rewards to the customer, the customer will return to the system each designated time frame. Because the customer will understand that if they do X, then they will get Y, and when they do X and receive Y, it will create a sense of accomplishment. In general, a brand can build loyalty through that sense of accomplishment.

One reason such a small repeatable task in the X-then-Y scenario builds loyalty is because when the X-then-Y scenario occurs for a customer it provides the customer with feelings associated with learning, motivation and pleasure. Even with the smallest amounts of success, positive emotions are created. Thus, the customer will be eager to repeat the actions that created those positive emotions. This is a type of “self-directed learning” and is why small timely tasks create long-lasting motivation to continue to interact with the middle out loyalty program.

Although FIG. 3 includes a plurality of screen shots from a digital device. It should be appreciated that any of the information presented in FIG. 3 could be provided in a physical form to the customer.

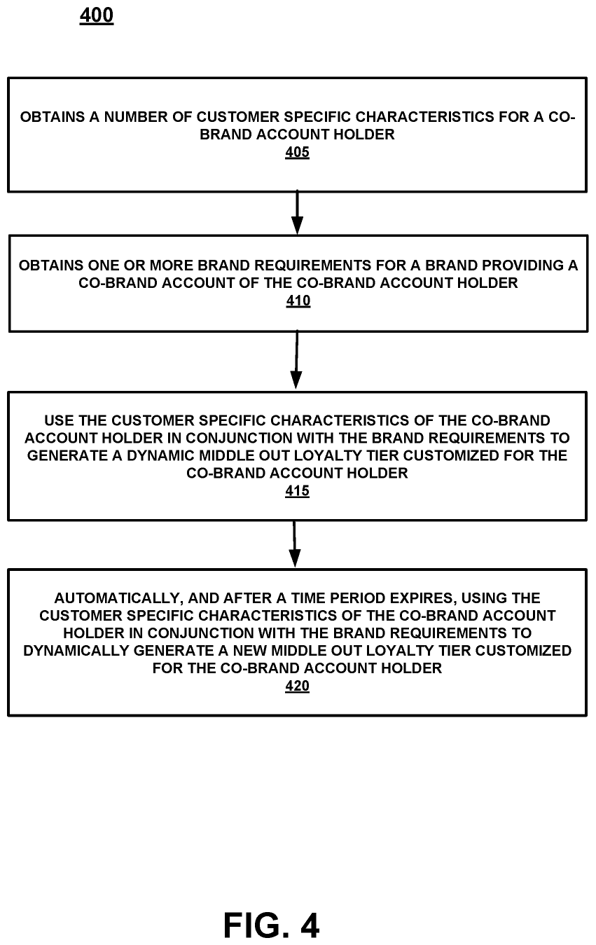

With reference now to FIG. 4, a flowchart 400 of a method for middle out loyalty is shown in accordance with an embodiment. In one embodiment, the middle out loyalty focuses on a value proposition, and makes something dynamic that can change with customers' needs and wants. By combining different rewards, offers, partners, and value, embodiments can be used to drive more foot traffic into a brand partners brick and mortar location(s). Moreover, by using the middle out loyalty as described herein, customers are more likely to make the credit account having the middle out loyalty their top-of-wallet card and create lasting loyalty with cardmembers.

By tailoring, adjusting, modifying, or otherwise providing a customer specific feature to the middle value (possibly even to values that are no longer the actual middle value), the brand (or the credit account provider) is able to provide a modified card product that will make the middle value a customer draw, that actually engages, intrigues, and otherwise causes the customer to want to use the cobrand card.

Referring now to 405 of FIG. 4, one embodiment obtains a number of customer specific characteristics of a co-brand account holder. The customer specific characteristics would be characteristics such as car owner or not, restaurant coinsure or not, outdoor or indoor activity preferences, activities, age, status (e.g., kid, single, parent, married with no kids, etc.), and the like.

With reference now to 410 of FIG. 4, one embodiment obtains one or more brand requirements for a brand providing a co-brand account of the co-brand account holder. In one embodiment, the brand requirements could include brand partners, non-competitive brands, or the like.

Referring now to 415 of FIG. 4, one embodiment uses the customer specific characteristics of the co-brand account holder in conjunction with the brand requirements to generate a dynamic middle out loyalty tier customized for the co-brand account holder.

With reference now to 420 of FIG. 4, one embodiment automatically, and after a time period expires, using the customer specific characteristics of the co-brand account holder in conjunction with the brand requirements to dynamically generate a new middle out loyalty tier customized for the co-brand account holder.

In one embodiment, the middle out loyalty offers tasks and time periods to complete the tasks, to a cardholder. For example, a task a day, three tasks a week, or the like. When the customer completes these tasks, they will earn bonus values. Thus, by performing daily, weekly or monthly tasks, customers can earn accelerated rewards through various activities. For example, a customer task could be visiting a store and scanning the barcode of a new product with their phone. Another task could incentivize cardmembers to pay their minimum balance on time, which would also build the brand reputation as one that cares about its customers.

In one embodiment, customers could be rewarded for donating (time, money, or the like) to charities during the holidays, which would also build the brand reputation as one that cares about its communities.

For example, a WorkOut company does not have a middle out loyalty program, but they do have a strong presence on social media. In addition to this, they also have several native apps for mobile devices such as Android and IOS. With apps, wearbles, smart clothes and other tech, they a have a high level of engagement with their customers.

However, the WorkOut company would benefit by using the middle out loyalty to motivate their customers to work out, which would in turn drives sales. Thus, middle out loyalty system aligns nicely with the type of customers the WorkOut company is targeting as well as the interaction that those customers are used to having with the brand.

In one embodiment, middle out loyalty is valuable for brands that have a varying demographic. For the WorkOut company, they target athletes and gym enthusiasts, but some of their top customers are mothers buying for their children. So, the middle out loyalty could provide some tasks that are spend tasks, and other tasks that are acts tasks (such as taking a class (such as a financial class), providing a customer review, going on a hike, taking a photo at a geographic feature, posting a photo of the purchased product in use to a social media account, etc.).

As such, the non-spend tasks can be used to change how customers view their co-branded card. Having challenges that promote good financial practices help with a cards image. Having ones that drive loyalty to the brand help brands connect with their customers. Sharing on social media would also allow a customer to enroll new customers, or to identify friends that are also card holders.

For example, a task could be a group task where 2-3 friends who also have the card can complete group challenges together. This would build loyalty, promote the product and brand through social means, and push the card to the top of the wallet.

### Example Computer System

With reference now to FIG. 5, portions of the technology for providing a communication composed of computer-readable and computer-executable instructions that reside, for example, in non-transitory computer-readable medium (or storage media, etc.) of a computer system. That is, FIG. 5 illustrates one example of a type of computer that can be used to implement embodiments of the present technology. FIG. 5 represents a system or components that may be used in conjunction with aspects of the present technology. In one embodiment, some or all of the components described herein may be combined with some or all of the components of FIG. 5 to practice the present technology.

FIG. 5 illustrates an example computer system 500 used in accordance with embodiments of the present technology. It is appreciated that computer system 500 of FIG. 5 is an example only and that the present technology can operate on or within a number of different computer systems including general purpose networked computer systems, embedded computer systems, routers, switches, server devices, user devices, various intermediate devices/artifacts, stand-alone computer systems, mobile phones, personal data assistants, televisions and the like. As shown in FIG. 5, computer system 500 of FIG. 5 is well adapted to having peripheral computer readable media 502 such as, for example, a disk, a compact disc, a flash drive, and the like coupled thereto.

Computer system 500 of FIG. 5 includes an address/data/control bus 504 for communicating information, and a processor 505A coupled to bus 504 for processing information and instructions. As depicted in FIG. 5, computer system 500 is also well suited to a multi-processor environment in which a plurality of processors 505A, 505B, and 505C are present. Conversely, computer system 500 is also well suited to having a single processor such as, for example, processor 505A. Processors 505A, 505B, and 505C may be any of various types of microprocessors. Computer system 500 also includes data storage features such as a computer usable volatile memory 508, e.g., random access memory (RAM), coupled to bus 504 for storing information and instructions for processors 505A, 505B, and 505C.

Computer system 500 also includes computer usable non-volatile memory 510, e.g., read only memory (ROM), coupled to bus 504 for storing static information and instructions for processors 505A, 505B, and 505C. Also present in computer system 500 is a data storage unit 512 (e.g., a magnetic disk drive, optical disk drive, solid state drive (SSD), and the like) coupled to bus 504 for storing information and instructions. Computer system 500 also can optionally include an alpha-numeric input device 514 including alphanumeric and function keys coupled to bus 504 for communicating information and command selections to processor 505A or processors 505A, 505B, and 505C. Computer system 500 also can optionally include a cursor control device 515 coupled to bus 504 for communicating user input information and command selections to processor 505A or processors 505A, 505B, and 505C. Cursor control device may be a touch sensor, gesture recognition device, and the like. Computer system 500 of the present embodiment can optionally include a display 518 coupled to bus 504 for displaying information.

Referring still to FIG. 5, display 518 of FIG. 5 may be a liquid crystal device, cathode ray tube, OLED, plasma display device or other display device suitable for creating graphic images and alpha-numeric characters recognizable to a user. Cursor control device 515 allows the computer user to dynamically signal the movement of a visible symbol (cursor) on display 518. Many implementations of cursor control device 515 are known in the art including a trackball, mouse, touch pad, joystick, non-contact input, gesture recognition, voice commands, bio recognition, and the like. In addition, special keys on alpha-numeric input device 514 capable of signaling movement of a given direction or manner of displacement. Alternatively, it will be appreciated that a cursor can be directed and/or activated via input from alpha-numeric input device 514 using special keys and key sequence commands.

Computer system 500 is also well suited to having a cursor directed by other means such as, for example, voice commands. Computer system 500 also includes an I/O device 520 for coupling computer system 500 with external entities. For example, in one embodiment, I/O device 520 is a modem for enabling wired or wireless communications between computer system 500 and an external network such as, but not limited to, the Internet or intranet. A more detailed discussion of the present technology is found below.

Referring still to FIG. 5, various other components are depicted for computer system 500. Specifically, when present, an operating system 522, applications 524, modules 525, and data 528 are shown as typically residing in one or some combination of computer usable volatile memory 508, e.g. random-access memory (RAM), and data storage unit 512. However, it is appreciated that in some embodiments, operating system 522 may be stored in other locations such as on a network or on a flash drive; and that further, operating system 522 may be accessed from a remote location via, for example, a coupling to the internet. In one embodiment, the present technology, for example, is stored as an application 524 or module 525 in memory locations within RAM 508 and memory areas within data storage unit 512. The present technology may be applied to one or more elements of described computer system 500.

Computer system 500 also includes one or more signal generating and receiving device(s) 530 coupled with bus 504 for enabling computer system 500 to interface with other electronic devices and computer systems. Signal generating and receiving device(s) 530 of the present embodiment may include wired serial adaptors, modems, and network adaptors, wireless modems, and wireless network adaptors, and other such communication technology. The signal generating and receiving device(s) 530 may work in conjunction with one (or more) communication interface 532 for coupling information to and/or from computer system 500. Communication interface 532 may include a serial port, parallel port, Universal Serial Bus (USB), Ethernet port, Bluetooth, thunderbolt, near field communications port, WiFi, Cellular modem, or other input/output interface. Communication interface 532 may physically, electrically, optically, or wirelessly (e.g., via radio frequency) couple computer system 500 with another device, such as a mobile phone, radio, or computer system.

Computer system 500 is only one example of a suitable computing environment and is not intended to suggest any limitation as to the scope of use or functionality of the present technology. Neither should the computing environment be interpreted as having any dependency or requirement relating to any one or combination of components illustrated in the example computer system 500.

The present technology may be described in the general context of computer-executable instructions, such as program modules, being executed by a computer. Generally, program modules include routines, programs, objects, components, data structures, etc., that perform particular tasks or implement particular abstract data types. The present technology may also be practiced in distributed computing environments where tasks are performed by remote processing devices that are linked through a communications network. In a distributed computing environment, program modules may be located in both local and remote computer-storage media including memory-storage devices.

The foregoing Description of Embodiments is not intended to be exhaustive or to limit the embodiments to the precise form described. Instead, example embodiments in this Description of Embodiments have been presented in order to enable persons of skill in the art to make and use embodiments of the described subject matter. Moreover, various embodiments have been described in various combinations. However, any two or more embodiments may be combined. Although some embodiments have been described in a language specific to structural features and/or methodological acts, it is to be understood that the subject matter defined in the appended claims is not necessarily limited to the specific features or acts described above. Rather, the specific features and acts described above are disclosed by way of illustration and as example forms of implementing the claims and their equivalents.

What is claimed is:

1. A computer-implemented method for dynamically assigning a middle out loyalty, said method comprising:
obtaining a number of customer specific characteristics for a co-brand account holder;
obtaining one or more brand requirements for a brand providing a co-brand account of the co-brand account holder;
using the customer specific characteristics of the co-brand account holder in conjunction with the brand requirements to generate a dynamic middle out loyalty offer customized for the co-brand account holder; and
automatically, and after a time period expires, using the customer specific characteristics of the co-brand account holder in conjunction with the brand requirements to dynamically generate a new middle out loyalty offer customized for the co-brand account holder.

2. The method of claim 1, further comprising:
presenting an opportunity for the co-brand account holder to perform a pre-defined number of tasks over a pre-defined time period;
determining if the co-brand account holder completed the pre-defined number of tasks within the pre-defined time period; and
providing an additional reward to the co-brand account holder when the co-brand account holder has successfully completed the pre-defined number of tasks within the pre-defined time period.

3. The method of claim 2, wherein the pre-defined number of tasks over the pre-defined time period further comprise:
providing a single task to the co-brand account holder;
providing a single task time period for the co-brand account holder to complete the single task;
determining if the co-brand account holder completed the single task within the single task time period; and
continuing to provide a different single task and single task time period to the co-brand account holder for the pre-defined time period.

4. The method of claim 2, wherein the pre-defined number of tasks over the pre-defined time period further comprise:
providing a plurality of different tasks to the co-brand account holder;
receiving, from the co-brand account holder, the selection of a single task from the plurality of different tasks;
providing a single task time period for the co-brand account holder to complete the selected single task;
determining if the co-brand account holder completed the single task within the single task time period; and
continuing to provide the plurality of different tasks to the co-brand account holder for the pre-defined time period.

5. The method of claim 2, wherein each task in the predefined number of tasks is selected from the group consisting of: a spending task and an acts task.

6. The method of claim 1, wherein the customer specific characteristics are selected from the group consisting of: a car owner or not, a restaurant coinsure or not, and a preference for an outdoor or an indoor activity.

7. The method of claim 1, wherein the customer specific characteristics are selected from the group consisting of: a customer's age, and a customer's status.

8. The method of claim 1, wherein the brand requirements are selected from the group consisting of: brand partners and non-competitive brands.

9. The method of claim 1, wherein the dynamic middle out loyalty offer customized for the co-brand account holder comprises:
presenting a number of different categories to be used as the middle out loyalty;
receiving a selection of a specific category from the number of different categories from the co-brand account holder; and
designating the selected specific category as the middle out loyalty offer for the co-brand account holder.

10. The method of claim 1, wherein the dynamic middle out loyalty offer customized for the co-brand account holder comprises:
presenting a number of different brands to be used as the middle out loyalty;
receiving a selection of a specific brand from the number of different brands from the co-brand account holder; and
designating the selected specific brand as the middle out loyalty offer for the co-brand account holder.

11. The method of claim 1, wherein the dynamic middle out loyalty offer customized for the co-brand account holder comprises:
presenting a number of different brands and categories to be used as the middle out loyalty;
receiving a selection of a specific brand or a specific category from the co-brand account holder; and
designating the selected specific brand or specific category as the middle out loyalty offer for the co-brand account holder.

12. A non-transitory computer-readable storage medium having instructions embodied therein that when executed cause a computer system to perform a method comprising:
obtaining a number of customer specific characteristics for a co-brand account holder;
obtaining one or more brand requirements for a brand providing a co-brand account of the co-brand account holder;
using the customer specific characteristics of the co-brand account holder in conjunction with the brand requirements to generate a dynamic middle out loyalty offer customized for the co-brand account holder; and
automatically, and after a time period expires, using the customer specific characteristics of the co-brand account holder in conjunction with the brand requirements to dynamically generate a new middle out loyalty offer customized for the co-brand account holder.

13. The non-transitory computer-readable storage medium of claim 12, further comprising:
presenting an opportunity for the co-brand account holder to perform a pre-defined number of tasks over a pre-defined time period;
determining if the co-brand account holder completed the pre-defined number of tasks within the pre-defined time period; and
providing an additional reward to the co-brand account holder when the co-brand account holder has successfully completed the pre-defined number of tasks within the pre-defined time period.

14. The non-transitory computer-readable storage medium of claim 12, wherein the customer specific characteristics are selected from the group consisting of: a car owner or not, a restaurant coinsure or not, a preference for an outdoor or an indoor activity, a customer's age, and a customer's status.

15. The non-transitory computer-readable storage medium of claim 12, wherein the dynamic middle out loyalty offer customized for the co-brand account holder comprises:
presenting a number of different categories to be used as the middle out loyalty;
receiving a selection of a specific category from the number of different categories from the co-brand account holder; and
designating the selected specific category as the middle out loyalty offer for the co-brand account holder.

16. The non-transitory computer-readable storage medium of claim 12, wherein the dynamic middle out loyalty offer customized for the co-brand account holder comprises:
presenting a number of different brands to be used as the middle out loyalty;
receiving a selection of a specific brand from the number of different brands from the co-brand account holder; and
designating the selected specific brand as the middle out loyalty offer for the co-brand account holder.

17. The non-transitory computer-readable storage medium of claim 12, wherein the dynamic middle out loyalty offer customized for the co-brand account holder comprises:
presenting a number of different brands and categories to be used as the middle out loyalty;
receiving a selection of a specific brand or a specific category from the co-brand account holder; and
designating the selected specific brand or specific category as the middle out loyalty offer for the co-brand account holder.

18. A computing system to manage information pertaining to anonymous and/or known customer activity both in store and online comprising:
a memory; and
one or more processors, the one or more processors to:
obtain a number of customer specific characteristics for a co-brand account holder;
obtain one or more brand requirements for a brand providing a co-brand account of the co-brand account holder;
use the customer specific characteristics of the co-brand account holder in conjunction with the brand requirements to generate a dynamic middle out loyalty offer customized for the co-brand account holder;
automatically, and after a time period expires, use the customer specific characteristics of the co-brand account holder in conjunction with the brand requirements to dynamically generate a new middle out loyalty offer customized for the co-brand account holder;
present an opportunity for the co-brand account holder to perform a pre-defined number of tasks over a pre-defined time period;
determine if the co-brand account holder completed the pre-defined number of tasks within the pre-defined time period; and
provide an additional reward to the co-brand account holder when the co-brand account holder has successfully completed the pre-defined number of tasks within the pre-defined time period.

19. The computing system of claim 18, wherein the one or more processors are further to:
provide a single task to the co-brand account holder;
provide a single task time period for the co-brand account holder to complete the single task;
determine if the co-brand account holder completed the single task within the single task time period; and
continue to provide a different single task and single task time period to the co-brand account holder for the pre-defined time period.

20. The computing system of claim 18, wherein the one or more processors are further to:
provide a plurality of different tasks to the co-brand account holder;
receive, from the co-brand account holder, a selection of a single task from the plurality of different tasks;
provide a single task time period for the co-brand account holder to complete the selected single task;
determine if the co-brand account holder completed the single task within the single task time period; and
continue to provide the plurality of different tasks to the co-brand account holder for the pre-defined time period.
